(19) United States
(12) Patent Application Publication
(10) Pub. No.: US 2021/0109426 A1
(43) Pub. Date: Apr. 15, 2021

(54) CLAMPING MECHANISM, CLAMPING DEVICE, AND PHOTOGRAPHING APPARATUS

(71) Applicant: SZ DJI TECHNOLOGY CO., LTD., Shenzhen (CN)

(72) Inventors: Shimeng Bei, Shenzhen (CN); Ruzhi Wang, Shenzhen (CN)

(73) Assignee: SZ DJI TECHNOLOGY CO., LTD., Shenzhen (CN)

(21) Appl. No.: 17/129,918

(22) Filed: Dec. 22, 2020

Related U.S. Application Data
(63) Continuation of application No. PCT/CN2019/083415, filed on Apr. 19, 2019.

(51) Int. Cl. G03B 17/56; F16B 2/12

(52) U.S. Cl. CPC G03B 17/561; G03B 17/566; F16B 2/12

(57) ABSTRACT

A clamping device for mounting a mobile terminal device to a hot shoe of an image photographing apparatus includes a quick release structure and a clamping assembly. The quick release structure includes a cold shoe fixing piece for connecting to a quick release interface of the hot shoe, and a first locking structure for selectively quickly locking the cold shoe fixing piece to the hot shoe, or quickly unlocking the cold shoe fixing piece from the hot shoe. The clamping assembly is configured to clamp the mobile terminal device, so that the mobile terminal device can be mounted, together with the quick release structure, to a quick release interface of the image photographing apparatus along with the clamping device. This facilitates quick and reliable mounting of the mobile terminal device to the image photographing apparatus, and quick removal of the mobile terminal device from the image photographing apparatus.

### RELATED APPLICATIONS

This application is a continuation application of PCT application No. PCT/CN2019/083415, filed on Apr. 19, 2019, and the content of which is incorporated herein by reference in its entirety.

### TECHNICAL FIELD

The present disclosure relates to the technical field of image photographing auxiliary apparatuses, specifically, a clamping mechanism, a clamping device, and a photographing apparatus.

### BACKGROUND

With the popularity of mobile phones, tablet computers, and other mobile terminal devices, various devices for holding a mobile phone or a tablet computer such as selfie sticks, mobile phone holders, etc., have been developed on the market. However, most of these devices have the problem of inconvenience in operation. In addition, although existing cameras are still commonly used in the film and television industry and in amateur photography, they cannot meet requirements of selfie tracking, constant-speed tracking of a target, or real-time monitoring during photographing at special angles.

In order to overcome the foregoing disadvantages of cameras, the manufacturers of existing mobile terminal devices (such as mobile phones or tablet computers) use a built-in wireless module of a camera to transmit an image from the camera to a mobile phone, and use the mobile phone to achieve selfie tracking, constant-speed tracking of a target, and in the case where a camera is photographing at a special angle and an operator cannot view a framed object through a display screen or a viewfinder of the camera, monitoring the framed object through a mobile phone, thereby greatly reducing limitations of the camera. However, although a mobile terminal device such as a mobile phone can transmit images from a camera via a wireless module, the mobile phone cannot be securely fixed to the camera, making it difficult to ensure the performance of framing or monitoring.

### SUMMARY

In order to solve the foregoing or other potential problems in the existing technology, embodiments of the present disclosure provide a clamping mechanism, a clamping device, and a photographing apparatus.

According to some embodiments of the present disclosure, a clamping mechanism for clamping a mobile terminal device is provided, the clamping mechanism includes a first clamping part and a second clamping part disposed opposite to the first clamping part, to enclose an accommodating space configured to accommodate a mobile terminal device; and a manual operation part, disposed outside the accommodating space and configured to drive the first clamping part and the second clamping part to move between a clamping position and a releasing position, where at the clamping position, the first clamping part and the second clamping part are capable of clamping the mobile terminal device, and at the releasing position, the first clamping part and the second clamping part are capable of releasing the mobile terminal device.

According to some embodiments of the present disclosure, a clamping device for mounting a mobile terminal device to a hot shoe of an image photographing apparatus is provided, including a quick release structure, including a cold shoe fixing piece to connect to a quick release interface of the hot shoe, and a first locking structure to selectively quickly lock the cold shoe fixing piece to the hot shoe, or quickly unlock the cold shoe fixing piece from the hot shoe; and a clamping assembly fixed to the cold shoe fixing piece to selectively clamp or release a mobile terminal device.

According to some embodiments of the present disclosure, photographing apparatus is provided, including a camera; and a clamping device, wherein a cold shoe fixing piece of the clamping device is clamped on a hot shoe of the camera, the clamping device includes: a quick release structure, including the cold shoe fixing piece to connect to a quick release interface of the hot shoe, and a first locking structure to selectively quickly lock the cold shoe fixing piece to the hot shoe or quickly unlock the cold shoe fixing piece from the hot shoe, and a clamping assembly fixed to the cold shoe fixing piece to selectively clamp or release a mobile terminal device.

In the solutions of the embodiments of the present disclosure, by means of providing the quick release and the clamping assembly, and clamping a mobile terminal device by the clamping assembly, the mobile terminal device can be mounted, together with the quick release structure, in the quick release interface of the image photographing apparatus along with the clamping device. This facilitates reliable mounting of the mobile terminal device to the image photographing apparatus, thereby ensuring an effect of framing or monitoring through the mobile terminal device; and facilitating quick removal of the mobile terminal device from the image photographing apparatus, thereby improving the convenience of user operation.

### BRIEF DESCRIPTION OF THE DRAWINGS

The foregoing and other objectives, features, and advantages of the embodiments of the present disclosure will be understood more easily with reference to the following detailed description of the accompanying drawings. In the accompanying drawings, a plurality of embodiments of the present disclosure will be described by way of example in a non-limiting manner.

FIG. 1 is a first schematic structural diagram of a quick release structure and a clamping assembly in a clamping device according to some exemplary embodiments of the present disclosure;

FIG. 2 is a second schematic structural diagram of a quick release structure and a clamping assembly in a clamping device according to some exemplary embodiments of the present disclosure;

FIG. 3 is a third schematic structural diagram of a quick release structure and a clamping assembly in a clamping device according to some exemplary embodiments of the present disclosure;

FIG. 4 is a cross-sectional view along A-A in FIG. 3;

FIG. 5 is a schematic exploded diagram of a clamping device according to some exemplary embodiments of the present disclosure;

FIG. 6 is a schematic exploded diagram of a clamping device according to another embodiment of the present disclosure;

FIG. 7 is a schematic exploded diagram of a quick release seat and a handle connection base in a clamping device according to some exemplary embodiments of the present disclosure;

FIG. 8 is a first schematic assembly diagram of a quick release structure, a clamping assembly, a quick release seat, and a handle connection base in a clamping device according to some exemplary embodiments of the present disclosure;

FIG. 9 is a second schematic assembly diagram of a quick release structure, a clamping assembly, a quick release seat, and a handle connection base in a clamping device according to some exemplary embodiments of the present disclosure;

FIG. 10 is a cross-sectional view along B-B in FIG. 9; and

FIG. 11 is a cross-sectional view along C-C in FIG. 9;

where,

1—clamping device;

11—quick release structure; 111—cold shoe fixing piece; 112—first locking structure;

13—clamping assembly; 131—clamping mechanism; 1311—first clamping part; 1312—second clamping part; 1313—manual operation part; 1314—elastic reset member; 1315—first engaging rack; 1316—second engaging rack; 1317—transmissive gear; 1318—elastic pad; 1319—decorative piece; 1320—cover body; 1320a—first cover; 1320b—second cover; 1320c—through hole; 1320d—non-slip pad; 1321—first mounting cover; 1322—second mounting cover;

133—support mechanism; 1331—rotating shaft; 1332—anti-fall-off cover; 1333—bottom housing; 1333a—first part; 1333b—second part; 1334—cover plate; 1335—pressure spring;

15—quick release seat; 151—cold shoe seat; 1511—dovetail slot; 1512—limiting screw; 152—base; 153—thumb nut; 154—Teflon gasket; 155—pre-tightening nut; 156—pre-tightening washer;

17—handle connection base; and 171—fixing seat.

### DETAILED DESCRIPTION

Some implementations of the present disclosure are described in detail below with reference to the accompanying drawings. Without conflict, the following embodiments and features of the embodiments may be combined with each other.

It should be understood that, in the description of the present disclosure, orientations or position relationships indicated by terms such as “upper”, “lower”, “top”, “bottom”, “inside”, and “outside” are orientations or position relationships shown in the accompanying drawings, and these terms are merely used to facilitate description of the present disclosure and simplify the description, but not to indicate or imply that the mentioned devices or elements must have a specific orientation or must be constructed and operated in a specific orientation, and therefore, should not be understood as a limitation to the present disclosure.

In the description of the present disclosure, “a plurality of” means at least two, for example, two or three, unless otherwise clearly and specifically limited.

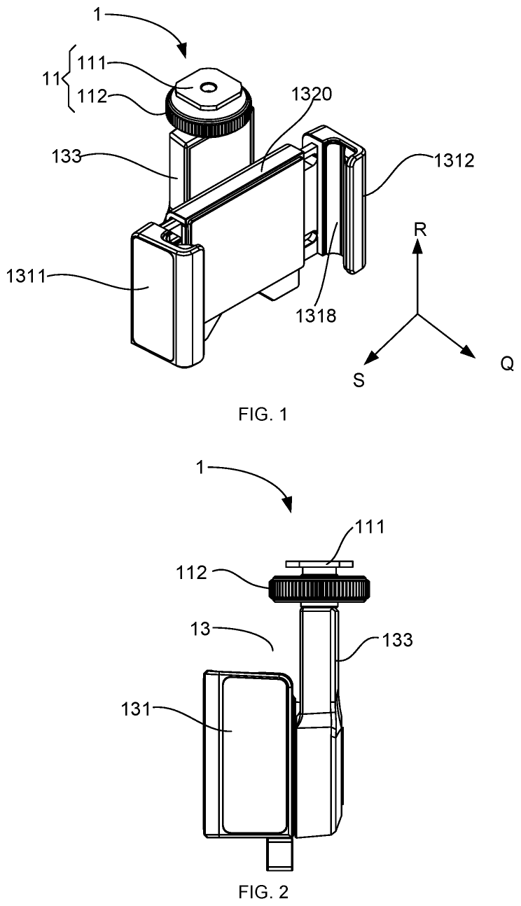

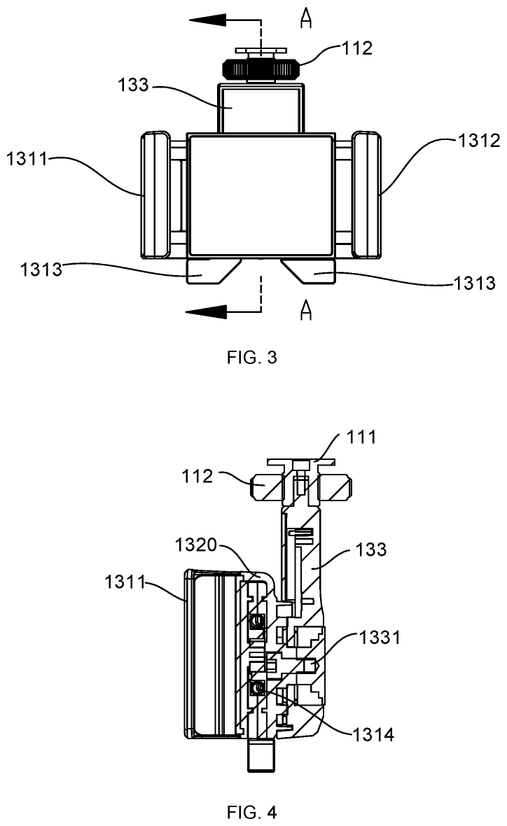

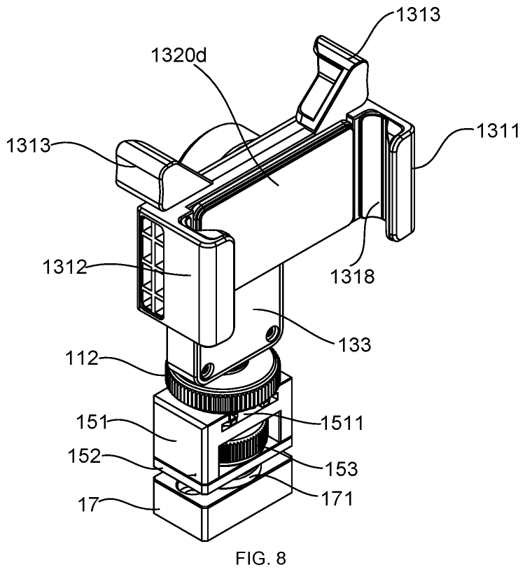

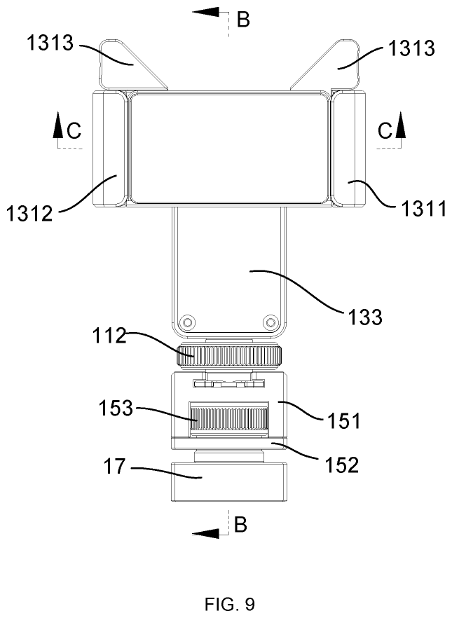

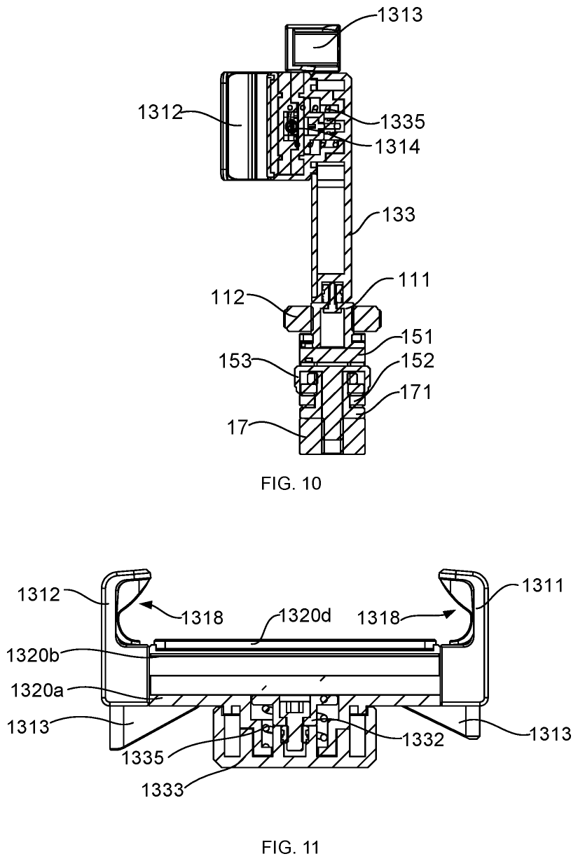

As shown in FIG. 1 to FIG. 11, a direction pointed by an arrow Q is forward, a direction pointed by an arrow S is upward, and a direction pointed by an arrow R is right. Some exemplary embodiments provide a clamping device 1, configured to mount a mobile terminal device to a hot shoe of an image photographing apparatus. For example, the clamping device 1 may be configured to clamp the mobile terminal device, and the clamping device 1 may be connected to the hot shoe of the image photographing apparatus, so as to mount the mobile terminal device to the hot shoe of the image photographing apparatus. The mobile terminal device may be provided with a communications module. The communications module may be in communication connection with the image photographing apparatus, so that an image (that is, a framed object) captured by the image photographing apparatus can be transmitted to the mobile terminal device. The mobile terminal device is provided with a display screen, so that a user can view the framed object through the display screen of the mobile terminal device. The mobile terminal device may include at least one of the following: a mobile phone, a tablet computer, or the like.

As shown in FIG. 1 to FIG. 3, the clamping device 1 may include a quick release structure 11 and a clamping assembly 13. The quick release structure 11 may include a cold shoe fixing piece 111 and a first locking structure 112. The cold shoe fixing piece 111 is configured to connect to a quick release interface of the hot shoe. The first locking structure 112 is configured to selectively quickly lock the cold shoe fixing piece 111 to the hot shoe or unlock the cold shoe fixing piece 111 from the hot shoe. The clamping assembly 13 is fixed to the cold shoe fixing piece 111. The clamping assembly 13 is configured to selectively clamp or release the mobile terminal device.

The quick release structure 11 may be configured to connect the clamping device 1 to the quick release interface of the hot shoe, so that a user can quickly remove or connect the clamping device 1 from or to the image photographing apparatus, thereby implementing disassembly and assembly of the mobile terminal device and the image photographing apparatus. The quick release interface of the hot shoe may include a mounting slot. For example, the mounting slot may be a dovetail slot.

The cold shoe fixing piece 111 in the quick release structure 11 may be configured to connect to the quick release interface of the hot shoe. A shape of the cold shoe fixing piece 111 may match that of the quick release interface, so that the cold shoe fixing piece 111 can quickly enter or exit the quick release interface, thereby implementing quick disassembly and assembly of the quick release structure 11 and the hot shoe, that is, implementing quick disassembly and assembly of the clamping device 1 and the image photographing apparatus, and facilitating disassembly and assembly of the mobile terminal device and the image photographing apparatus. In addition, a common image photographing apparatus such as a single lens reflex camera is provided with a universal hot shoe. Therefore, the quick release structure 11 on the clamping device 1 can enable quick mounting of the clamping device to the quick release interface of the hot shoe of the camera, thereby reducing other support and fixing structures, making the structure simpler and mounting easier.

As shown in FIG. 4 to FIG. 6, for example, the cold shoe fixing piece 111 may include a fixing piece body for engaging with the quick release interface. A shape of the fixing piece body may match that of the quick release interface. One end of the fixing piece body facing the clamping assembly 13 may be provided with a stud. The stud and the fixing piece body may be integrally disposed. The stud may be fixedly connected to the clamping assembly 13. For example, the stud may be inserted in and in interference fit with the clamping assembly 13, to ensure reliability of the connection therebetween. Alternatively, the cold shoe fixing piece 111 may be disposed therethrough with a screw, and the screw is tightly connected to the clamping assembly 13, so that the cold shoe fixing piece 111 is tightly connected to the clamping assembly 13, thereby facilitating subsequent disassembly between the cold shoe fixing piece 111 and the clamping assembly 13.

The first locking structure 112 in the quick release structure 11 may selectively quickly lock the cold shoe fixing piece 111 to the hot shoe or quickly unlock the cold shoe fixing piece 111 from the hot shoe. That is, in the case where the mobile terminal device needs to be mounted to the image photographing apparatus, when the cold shoe fixing piece 111 reaches a preset position in the quick release interface, the first locking structure 112 may quickly lock the cold shoe fixing piece 111 to the hot shoe. In the case where the mobile terminal device needs to be removed from the image photographing apparatus, the first locking structure 112 may be operated to release the cold shoe fixing piece 111, so that the cold shoe fixing piece 111 can be taken out of the quick release interface.

For example, the first locking structure 112 may include a locking nut engaged with the stud, to tightly press the cold shoe fixing piece 111 in the quick release interface through the engagement between the locking nut and the stud. When the mobile terminal device needs to be mounted to the image photographing apparatus, the cold shoe fixing piece 111 may be inserted into the quick release interface first, and then the locking nut is screwed tightly relative to the stud on the cold shoe fixing piece 111, to press the cold shoe fixing piece 111 into the quick release interface, thereby quickly locking the cold shoe fixing piece 111 to the hot shoe. When the mobile terminal device needs to be removed from the image photographing apparatus, the locking nut may be unscrewed, and then the cold shoe fixing piece 111 is taken out of the quick release interface, thereby quickly unlocking the cold shoe fixing piece 111 from the hot shoe.

Certainly, a specific structure of the first locking structure 112 is not limited thereto, and here is merely an example in some exemplary embodiments. For example, the first locking structure 112 may further include a fastener such as a screw that passes through the cold shoe fixing piece 111 and is then tightly connected to the hot shoe.

The clamping assembly 13 connected to the cold shoe fixing piece 111 is configured to clamp the mobile terminal device, so that the clamping assembly 13 and the mobile terminal device clamped by the clamping assembly 13 can be mounted to the image photographing apparatus together with the cold shoe fixing piece 111. The cold shoe fixing piece 111 may be fixedly connected to the clamping assembly 13, to ensure reliability of the connection between the mobile terminal device and the image photographing apparatus. For example, the cold shoe fixing piece 111 may be detachably connected to the clamping assembly 13 through a detachable connection such as screwing or clamping. Alternatively, the cold shoe fixing piece 111 and the clamping assembly 13 may be integrally disposed or fixed by welding. A manner in which the cold shoe fixing piece 111 may be fixedly connected to the clamping assembly 13 is not specifically limited herein in some exemplary embodiments.

The clamping assembly 13 may selectively clamp or release the mobile terminal device, so that the mobile terminal device can be mounted to the image photographing apparatus or removed from the image photographing apparatus along with the clamping device 1. Certainly, when the mobile terminal device is not required, the clamping assembly 13 alone may be adjusted to a loosened state to release the mobile terminal device, so that a user can remove the mobile terminal device from the clamping assembly 13. For example, the clamping assembly 13 may include a first part and a second part. There is relative movement such as relative rotation or relative sliding between the first part and the second part. When one of the first part and the second part moves away from the other, that is, when the first part and the second part move away from each other, the clamping assembly 13 is configured to release the mobile terminal device.

In the clamping device 1 provided in some exemplary embodiments, by means of providing the quick release structure 11 and the clamping assembly 13, and clamping the mobile terminal device by the clamping assembly 13, the mobile terminal device can be mounted, together with the quick release structure 11, in the quick release interface of the image photographing apparatus along with the clamping device 1. This facilitates reliable mounting of the mobile terminal device to the image photographing apparatus, thereby ensuring an effect of framing or monitoring through the mobile terminal device; and facilitating quick removal of the mobile terminal device from the image photographing apparatus, thereby improving the convenience of user operation.

The following describes the structure of the clamping assembly 13 in some exemplary embodiments by way of example.

In some examples, as shown in FIG. 1 to FIG. 6, the clamping assembly 13 includes a clamping mechanism 131 connected to the cold shoe fixing piece 111. The clamping mechanism 131 includes a first clamping part 1311, a second clamping part 1312, and a manual operation part 1313. The first clamping part 1311 and the second clamping part 1312 are disposed opposite to each other and enclose to form an accommodating space for accommodating the mobile terminal device. The manual operation part 1313 is disposed outside the accommodating space, and the manual operation part 1313 can drive the first clamping part 1311 and the second clamping part 1312 to move between a clamping position and a releasing position. At the clamping position, the first clamping part 1311 and the second clamping part 1312 clamp the mobile terminal device. At the releasing position, the first clamping part 1311 and the second clamping part 1312 release the mobile terminal device.

For example, the first clamping part 1311 and the second clamping part 1312 may be respectively located on two opposite sides of the mobile terminal device, so as to reliably clamp the mobile terminal device. For ease of description, a direction in which the mobile terminal device faces the first clamping part 1311 is used as an upward direction, as shown by the direction pointed by the arrow S in FIG. 1. Thus, a direction in which the mobile terminal device faces away from the first clamping part 1311 is a downward direction. A side on which the display screen of the mobile terminal device is located is a front side, that is, a side on which the clamping assembly 13 faces a user is the front side, as shown by the direction pointed by the arrow Q in FIG. 1. Thus, a side of the clamping assembly 13 opposite to the front side is a rear side. The other two sides are left and right. The direction pointed by the arrow R in FIG. 1 is right.

The first clamping part 1311 may include a first clamping plate. The first clamping plate may be in a shape of a flat plate. At least a part of a front surface of the first clamping plate may be used for coming into contact with the mobile terminal device. An upper end of the first clamping plate is provided with a first edge that is folded forward. The first edge may also be in contact with the mobile terminal device. The second clamping part 1312 may include a second clamping plate. The second clamping plate may be in a shape of a flat plate. At least a part of a front surface of the second clamping plate may be used for coming into contact with the mobile terminal device. A lower end of the second clamping plate is provided with a second edge that is folded forward. The second edge may also be in contact with the mobile terminal device. The first clamping plate and the second clamping plate may be located on a rear side of the mobile terminal device. The first edge and the second edge may be respectively located on an upper side and a lower side of the mobile terminal device, so as to prevent the first clamping part 1311 and the second clamping part 1312 from blocking the display screen of the mobile terminal device, and reduce or even avoid interference to a sight line of a user. The first clamping plate, the second clamping plate, the first edge, and the second edge jointly enclose an accommodating space for accommodating the mobile terminal device.

The first clamping part 1311 may be connected to the manual operation part 1313, so that a user can move the first clamping part 1311 relative to the second clamping part 1312 through the manual operation part 1313, thereby improving user convenience. For example, the user may move the first clamping part 1311 towards the second clamping part 1312 through the manual operation part 1313, to a clamping position at which the mobile terminal device can be clamped. The user may alternatively move the first clamping part 1311 away from the second clamping part 1312 through the manual operation part 1313, to a releasing position at which the mobile terminal device can be released (or loosened). The manual operation part 1313 may be disposed outside the accommodating space, for example, may be disposed on a left side, a right side, a rear side, or the like of the first clamping part 1311, so as not to affect contact between the first clamping part 1311 and the mobile terminal device.

The second clamping part 1312 may be connected to the manual operation part 1313, so that a user can move the second clamping part 1312 relative to the first clamping part 1311 through the manual operation part 1313, to thereby improving user convenience. For example, the user may move the second clamping part 1312 towards the first clamping part 1311 through the manual operation part 1313, to a clamping position at which the mobile terminal device can be clamped. The user may alternatively move the second clamping part 1312 away from the first clamping part 1311 through the manual operation part 1313, to a releasing position at which the mobile terminal device can be released (or loosened). The manual operation part 1313 may be disposed outside the accommodating space, for example, may be disposed on a left side, a right side, a rear side, or the like of the second clamping part 1312, so as not to affect contact between the second clamping part 1312 and the mobile terminal device.

In some examples, the first clamping part 1311 and the second clamping part 1312 may be each provided with the manual operation part 1313, thereby improving user convenience. In other examples, one of the first clamping part 1311 and the second clamping part 1312 may be provided with the manual operation part 1313, to simplify the structure of the clamping mechanism 131.

In some examples, the manual operation part 1313 may include a pressing protrusion. The pressing protrusion is configured to drive the first clamping part 1311 and the second clamping part 1312 to move from the clamping position to the releasing position. The pressing protrusion extends along a direction away from the accommodating space and protrudes out of the first clamping part 1311 and/or the second clamping part 1312, thereby improving user convenience. The pressing protrusion may be spherical, columnar, or in another shape. The pressing protrusion may have a pressing surface for user operation. The pressure surface may be provided with a pressing recess matching the shape of a user finger, to prevent the user finger from slipping off the pressing surface during an operation. Alternatively, the pressing surface may be provided with a convex strip(s), a spherical protrusion(s), or the like, to increase friction between the pressing surface and the user finger, thereby helping to prevent the finger from slipping off the pressing surface during the user operation.

In some examples, the pressing protrusion may be disposed on one of the first clamping part 1311 and the second clamping part 1312. In some other examples, the first clamping part 1311 and the second clamping part 1312 are each provided with the pressing protrusion, and the two pressing protrusions are disposed opposite to each other. For example, the two pressing protrusions may be respectively disposed on a left side (or a right side) of the first clamping part 1311 and the second clamping part 1312, and are disposed opposite to each other up and down.

The pressing protrusion of the first clamping part 1311 may be located on a side of the second clamping part 1312, that is, the pressing protrusion of the first clamping part 1311 is disposed on a side of the first clamping part 1311 facing the second clamping part 1312. In other words, the pressing protrusion of the first clamping part 1311 is disposed on a lower side of the first clamping part 1311. The pressing protrusion of the second clamping part 1312 may be located on a side of the first clamping part 1311, that is, the pressing protrusion of the second clamping part 1312 may be disposed on a side of the second clamping part 1312 facing the first clamping part 1311. In other words, the pressing protrusion of the second clamping part 1312 may be located on an upper side of the second clamping part 1312.

In this way, it is convenient for the user to simultaneously drive the first clamping part 1311 and the second clamping part 1312 to move through the two pressing protrusions, which can reduce the movement distance of a single clamping part, thereby reducing the time required for clamping the mobile terminal device. For example, the user may apply a force to the two pressing protrusions to make the two pressing protrusions simultaneously move towards each other, so that the first clamping part 1311 and the second clamping part 1312 move towards each other simultaneously to reach the clamping position to clamp the mobile terminal device.

In some examples, the clamping mechanism 131 may further include an elastic reset member 1314. The elastic reset member 1314 is configured to reset the first clamping part 1311 and the second clamping part 1312 to the clamping position from the releasing position. That is, when the first clamping part 1311 and the second clamping part 1312 are at the releasing position under the action of an external force, the elastic reset member 1314 is in a stretched state and thus stores elastic potential energy. After withdrawal of the external force, under the action of the elastic potential energy of the elastic reset member 1314, the first clamping part 1311 and the second clamping part 1312 move towards each other to reach the clamping position, and the first clamping part 1311 and the second clamping part 1312 reliably remain at the clamping position, so as to reliably clamp the mobile terminal device.

It may be understood that, when the first clamping part 1311 and the second clamping part 1312 are at the clamping position, the elastic reset member 1314 is still in the stretched state and has certain elastic potential energy, so that the first clamping part 1311 and the second clamping part 1312 reliably clamp the mobile terminal device. The elastic potential energy of the elastic reset member 1314 when the first clamping part 1311 and the second clamping part 1312 are at the clamping position is lower than the elastic potential energy of the elastic reset member 1314 when the first clamping part 1311 and the second clamping part 1312 are at the releasing position.

In some examples, the elastic reset member 1314 may include at least one tension spring. The tension spring has a first end and a second end opposite to each other. The first end of the tension spring may be fixed to one of the first clamping part 1311 and the second clamping part 1312. The second end of the tension spring may be fixed to the other one of the first clamping part 1311 and the second clamping part 1312. For example, the first end of the tension spring is fixed to the first clamping part 1311, and the second end of the tension spring is fixed to the second clamping part 1312.

Alternatively, the first end of the tension spring may be fixed to the first clamping part 1311, and the second end of the tension spring may be mounted at a fixing position, where the fixing position may be disposed on another component such as a spring mounting cover, so that the tension spring can pull the first clamping part 1311 from the releasing position to the clamping position. The spring mounting cover may be connected to the second clamping part 1312 or a cover body 1320. The cover body 1320 may be configured to support the first clamping part 1311 and the second clamping part 1312, and is slidably connected to the first clamping part 1311 and the second clamping part 1312. The spring mounting cover may include a first mounting cover 1321 and a second mounting cover 1322 that are buckled with each other. The first mounting cover 1321 or the second mounting cover 1322 is provided with a column or a hook for connecting to the tension spring.

Alternatively, the first end of the tension spring may be fixed to the second clamping part 1312, and the second end of the tension spring may be mounted at a fixing position. In this case, the second end of the spring may be fixed in a way similar to that mentioned in the foregoing description.

The tension spring may be fixed in a common fixing manner such as welding, hooking, or clamping. For example, a lower end of the first clamping part 1311 and an upper end of the second clamping part 1312 may each be provided with a connection hook. The first end and the second end of the tension spring may each be provided with a connection ring. The two connection rings may be respectively engaged with the two connection hooks. When a plurality of tension springs is provided, the plurality of tension springs may be symmetrically disposed relative to a center line of the first clamping part 1311 along an up-and-down direction, so that the first clamping part 1311 and the second clamping part 1312 are uniformly stressed, thereby making the mobile terminal device uniformly stressed.

In other examples, the elastic reset member 1314 may include a column made of an elastic material, such as a rubber column. Certainly, the elastic reset member 1314 may include the tension spring(s) and a rubber column(s).

In some exemplary embodiments, in a specific implementation process, when the mobile terminal device needs to be clamped, the first clamping part 1311 and the second clamping part 1312 may be first driven by the manual operation part 1313 to move from the clamping position drive to the releasing position. In this process, the elastic reset member 1314 is further stretched. The mobile terminal device is placed into the accommodating space enclosed by the first clamping part 1311 and the second clamping part 1312; subsequently the force applied to the manual operation part 1313 is withdrawn; under the action of the elastic potential energy of the elastic reset member 1314, the elastic reset member 1314 drives the first clamping part 1311 and the second clamping part 1312 to move towards the clamping position, until the first clamping part 1311 and the second clamping part 1312 reach the clamping position at which the mobile terminal device can be clamped, and the first clamping part 1311 and the second clamping part 1312 are make to stay at the clamping position.

In some examples, the first clamping part 1311 is provided with first engaging rack 1315 facing the second clamping part 1312. The second clamping part 1312 is provided with second engaging rack 1316 facing the first clamping part 1311. The first engaging rack 1315 are engaged with the second engaging rack 1316, so that the first clamping part 1311 and the second clamping part 1312 can move in opposite directions under the operation of the manual operation part 1313, thereby clamping or releasing the mobile terminal device.

For example, when a user drives, through the manual operation part 1313 on the first clamping part 1311, the first clamping part 1311 to move downwards towards the clamping position, the first clamping part drives the first engaging rack 1315 thereof to move, the first engaging rack 1315 drives the second engaging rack 1316 engaged with the first engaging rack 1315 to move along a direction opposite to the first engaging rack 1315, and further, the second engaging rack 1316 drive the second clamping part to move along a direction away from the first clamping part, that is, the second engaging rack 1316 drive the second clamping part to move upwards towards the clamping position, thereby clamping the mobile terminal device. Correspondingly, an implementation process of releasing the mobile terminal device is similar to the implementation process of clamping the mobile terminal device.

In some examples, the first engaging rack 1315 may be a rack, and the rack extends along the up-and-down direction. The rack may be fixedly connected to the first clamping part 1311, or the first clamping part 1311 may be integrally provided with the rack. In this case, the second engaging rack 1316 may include a gear disposed on the second clamping part 1312. The first clamping part 1311 may be driven to move, to drive the second clamping part 1312 to move along a direction away from the first clamping part 1311.

In some other examples, the second engaging rack 1316 may be a rack, and the rack extends along the up-and-down direction. The rack may be fixedly connected to the second clamping part 1312, or the second clamping part 1312 may be integrally provided with the rack. In this case, the first engaging rack 1315 may include a gear disposed on the first clamping part 1311. The second clamping part 1312 may be driven to move, to drive the first second clamping part 1311 to move along a direction away from the second clamping part 1312.

In other examples, the first engaging rack 1315 and the second engaging rack 1316 each may be a rack. The clamping mechanism 131 may further include transmissive gear teeth 1317. The first engaging rack 1315 are in transmissive connection with the second engaging rack 1316 via the transmissive gear teeth 1317, so that the first engaging rack 1315 and the second engaging rack 1316 can move along opposite directions. Certainly, in this case, one of the first engaging rack 1315 and the second engaging rack 1316 may be a rack, and the other may be a gear. The transmissive gear teeth 1317 may be disposed on another component of the clamping device 1, for example, may be disposed on a component that is stationary relative to the mobile terminal device after the mobile terminal device is placed in place.

In some examples, an inner surface of the first clamping part 1311 and/or the second clamping part 1312 for coming into contact with the mobile terminal device is provided with an elastic pad 1318. For example, the inner surface of each of the first clamping part 1311 and the second clamping part 1312 is provided with the elastic pad 1318, to cushion, through elastic compression deformation of the elastic pad 1318, a force applied by the first clamping part 1311 and the second clamping part 1312 to the mobile terminal device, so as to prevent the mobile terminal device from being damaged. In addition, when the force applied by the first clamping part 1311 and the second clamping part 1312 to the mobile terminal device causes the compression deformation of the elastic pad 1318, the elastic pad 1318 has particular elastic potential energy. Under the action of the elastic potential energy of the elastic pad 1318, the elastic pad 1318 closely abuts against the mobile terminal device, thereby more reliably clamping the mobile terminal device.

The elastic pad 1318 includes at least a part for coming into contact with a side of the mobile terminal device. That is, the elastic pad 1318 of the first clamping part 1311 includes at least a part in contact with an upper side of the mobile terminal device. The elastic pad 1318 of the second clamping part 1312 includes at least a part in contact with a lower side of the mobile terminal device. In addition, a surface of the part of the elastic pad 1318 for coming into contact with the side of the mobile terminal device may be a cambered surface, so as to better match the side of the mobile terminal device. Certainly, in some examples, the elastic pad 1318 may alternatively include a part in contact with a rear side (that is, a back side) of the mobile terminal device.

In some examples, an outer surface of the first clamping part 1311 facing away from the mobile terminal device may be provided with a decorative piece 1319. For example, a rear side of the first clamping part 1311 may be provided with the decorative piece 1319, to block, through the decorative piece 1319, a component such as the elastic reset member 1314 connected to the first clamping part 1311 and/or the first engaging rack 1315 disposed on the first clamping part 1311, so as to prevent a factor of an external environmental from affecting a service life of the component such as the elastic reset member 1314 and/or the first engaging rack 1315, and improve integrity of the first clamping part 1311. In another example, an upper side of the first clamping part 1311 may be provided with the decorative piece 1319.

In some examples, an outer surface of the second clamping part 1312 facing away from the mobile terminal device may be provided with a decorative piece 1319. In some examples, a rear side of the second clamping part 1312 is provided with the decorative piece 1319, to block, through the decorative piece 1319, a component such as the elastic reset member 1314 connected to the second clamping part 1312 and/or the second engaging rack 1316 disposed on the second clamping part 1312, so as to prevent a factor of an external environment from affecting a service life of the component such as the elastic reset member 1314 and/or the second engaging rack 1316, and improve integrity of the second clamping part 1312. In another example, a lower side of the second clamping part 1312 may be provided with the decorative piece 1319.

In some examples, the clamping mechanism 131 may further include a cover body 1320. The first clamping part 1311 and the second clamping part 1312 are slidably disposed on a first surface of the cover body 1320, so that the first clamping part 1311 and the second clamping part 1312 can be connected to another component via the cover body 1320, and the cover body 1320 can protect the first clamping part 1311 and the second clamping part 1312. For example, the cover body 1320 may include a plate body, and the plate body may be provided with a sliding groove. The first clamping part 1311 and the second clamping part 1312 are each provided with a sliding block engaged with the sliding groove, so as to guide a movement direction of each of the first clamping part 1311 and the second clamping part 1312 through the engagement between the sliding block and the sliding groove. The first clamping part 1311 and the second clamping part 1312 may be respectively disposed on an upper portion and a lower portion of the plate body.

In some examples, the clamping mechanism 131 may be rotatable relative to the cold shoe fixing piece 111, that is, the clamping mechanism 131 is rotatably connected to the cold shoe fixing piece 111, so that the clamping mechanism 131 can drive the mobile terminal device to rotate relative to the image photographing apparatus. For example, the clamping mechanism 131 can selectively rotate the mobile terminal device to a horizontal position or a vertical position.

For example: the clamping mechanism 131 may be provided with a rotating column. The stud of the cold shoe fixing piece 111 may be provided with an engagement hole. The rotating column is rotatably disposed in the engagement hole. In a possible implementation, a rubber gasket may be provided between the engagement hole and the rotating column, so that friction between the rotating column and the rubber gasket (or between a wall of the engagement hole and the rubber gasket) can be overcome by an external force, and the clamping mechanism 131 is driven to rotate relative to the cold shoe fixing piece 111. In addition, after rotating to a preset position, the clamping mechanism 131 can be further locked by the friction between the rotating column and the rubber gasket.

In another possible implementation, when the rotating column rotates to an appropriate position in the engagement hole, a fastener such as a screw that passes through the cold shoe fixing piece 111 may be tightly connected to the rotating column, so as to lock the clamping mechanism 131 relative to the cold shoe fixing piece 111. Certainly, an implementation manner regarding the rotation and locking of the cold shoe fixing piece 111 relative to the clamping mechanism 131 is not limited thereto, and this is only an example for description in some exemplary embodiments.

In some examples, the clamping assembly 13 may further include a support mechanism 133. The clamping mechanism 131 is rotatably connected the support mechanism 133. The support mechanism 133 is fixed to the cold shoe fixing piece 111.

The support mechanism 133 may be fixed to the cold shoe fixing piece 111 in a common manner such as screwing, clamping, or welding. Alternatively, the support mechanism 133 and the cold shoe fixing piece 111 may be integrally provided. The support mechanism 133 may be rotatably connected to the cover body 1320 of the clamping mechanism 131. For example, a rotating shaft 1331 is formed on an inner surface of the support mechanism 133 facing the cover body 1320. The cover body 1320 is rotatably sleeved over the rotating shaft 1331. The cover body 1320 is provided with a shaft hole matching the rotating shaft 1331. A rubber gasket may be disposed between the shaft hole and the rotating shaft 1331, so as to lock the cover body 1320 relative to the support mechanism 133 when the cover body 1320 rotates to a preset position relative to the support mechanism 133.

An anti-fall-off cover 1332 for preventing the cover body 1320 from falling off the rotating shaft 1331 is mounted on a free end the rotating shaft 1331. The free end of the rotating shaft 1331 may be connected to the anti-fall-off cover 1332 in a detachable connection manner such as screwing or clamping, so as to facilitate the disassembly and assembly thereof. Alternatively, the free end of the rotating shaft 1331 and the anti-fall-off cover 1332 may be integrally provided. The anti-fall-off cover 1332 may abut against the cover body 1320, to prevent the rotating shaft 1331 from falling out of the shaft hole of the cover body 1320.

In some examples, the clamping assembly 13 may further include a second locking structure. The second locking structure is configured to selectively lock the cover body 1320 and the support mechanism 133 in at least two locking positions. For example, the second locking mechanism is configured to selectively lock the cover body 1320 and the support mechanism 133 to a first locking location that makes the mobile terminal device to be at a horizontal position, and a second locking location that makes the mobile terminal device at a vertical position.

Two neighboring locking positions are perpendicular to each other. For example, one of the two neighboring locking positions causes the mobile terminal device to be at a horizontal position, and the other one causes the mobile terminal device to be at a vertical position, for easy observation by a user.

For example, the second locking structure may include at least one protrusion and at least two slots that are disposed at intervals. The protrusion may be disposed on one of the cover body 1320 and the support mechanism 133. The slots may be disposed on the other one of the cover body 1320 and the support mechanism 133. The protrusion is accommodated in one of the slots.

In this example, for a protrusion, when the protrusion is located in different slots, the cover body 1320 and the support mechanism 133 are at different locking positions. There may be one or more protrusions. When a plurality of protrusions is provided, a quantity of the protrusions matches a quantity of slots, so that each protrusion may match a corresponding slot at each locking position, in order to reliably lock the cover body 1320 and the support mechanism 133. In some examples, an elastic member such as a tension spring may be disposed between the support mechanism 133 and the cover body 1320, so that the protrusion can be accommodated in the slot and maintained therein by the elastic potential energy of the tension spring.

The implementation process in this example will be described below by using an example in which the cover body 1320 is provided with two slots and the support mechanism 133 is provided with a protrusion. The cover body 1320 is provided with two slots. The two slots are disposed perpendicular to each other. For example, one slot extends up and down, and the other slot extends left and right. The support mechanism 133 may be provided with a protrusion. In this way, when a position of the mobile terminal device needs to be adjusted, the protrusion on the support mechanism 133 may be driven by an external force to exit one of the slots, and the cover body 1320 is caused to rotate relative to the support mechanism 133. In addition, when the cover body 1320 rotates to a position at which the protrusion on the support mechanism 133 is aligned with the other slot, the external force is withdrawn. Under the action of the tension spring, the protrusion on the support mechanism 133 can enter the slot, thereby locking the cover body 1320.

Certainly, the cover body 1320 may alternatively be provided with four slots. Every two neighboring slots are disposed perpendicular to each other (that is, a central angle corresponding to the two neighboring slots is a right angle), and every two neighboring slots have an equal distance. The support mechanism 133 may be provided with one or more protrusions. When a plurality of protrusions is provided, a distance between every two neighboring protrusions needs to match a distance between two neighboring slots. For example, a quantity of protrusions may be the same as a quantity of slots, and distribution of the protrusions may match distribution of the slots, so as to ensure reliable locking of the cover body 1320 and the support mechanism 133.

In some examples, the clamping assembly 13 may further include an unlocking structure. The unlocking structure is configured to unlock the cover body 1320 and the support mechanism 133 from the locking position.

For example, the unlocking structure may include a conical protruding frustum and a conical slot. The conical protruding frustum is disposed on one of the cover body 1320 and the support mechanism 133. The conical slot is disposed on the other one of the cover body 1320 and the support mechanism 133. The conical protruding frustum is inserted into the conical slot.

For example, the cover body 1320 is provided with a conical slot, and the support mechanism 133 is provided with a conical protruding frustum. The conical slot and the conical protruding frustum each have a cross section area gradually decreasing from front to back along a direction perpendicular to an axial direction thereof. For example, the cross section of each of the conical slot and the conical protruding frustum is circular. In this case, the conical slot and the conical protruding frustum each have a diameter gradually decreasing from front to back.

The second locking structure may include: at least one protrusion on the conical protruding frustum and at least two slots that are disposed at intervals in the conical slot. The at least one protrusion is accommodated in one of the slots. For example, there are two slots. A central angle corresponding to the two slots is 90 degrees, so that the mobile terminal device can switch between a horizontal position and a vertical position. Certainly, there may be alternatively four slots. In this case, a central angle corresponding to every two neighboring slots is 90 degrees, so that the mobile terminal device can switch between a horizontal and a vertical position.

The unlocking structure may further include an elastic member. Two ends of the elastic member respectively abut against the cover body 1320 and the support mechanism 133. For example, the elastic member may be a pressure spring 1335 sleeved over the rotating shaft 1331, so that the elastic potential energy of the pressure spring 1335 drives the protrusion to abut against a wall of the slot, thereby helping reliably position the cover body 1320 and the mobile terminal device relative to the support mechanism 133 and the image photographing apparatus.

For example, an upper side of a front end of the conical slot may be provided with a slot, and a right side of the front end of the conical slot is also provided with a slot. The conical protruding frustum is provided with a protrusion. The protrusion may be accommodated in the slot on the upper side, so that the mobile terminal device is in a vertical position. When the mobile terminal device needs to switch to a horizontal position, the cover body 1320 may be pressed first, so that the protrusion can exit the slot on the upper side, and the pressure spring 1335 is compressed. Subsequently, the cover body 1320 is rotated relative to the support mechanism 133, until the protrusion is aligned with the slot on the right side, and the force applied on the cover body 1320 is withdrawn. At the same time, under the action of the elastic potential energy of the pressure spring 1335, the pressure spring 1335 presses the cover body 1320 to move along a direction away from the support mechanism 133, and drives the protrusion to enter the slot on the right side, thereby locking the cover body 1320 to the support mechanism 133.

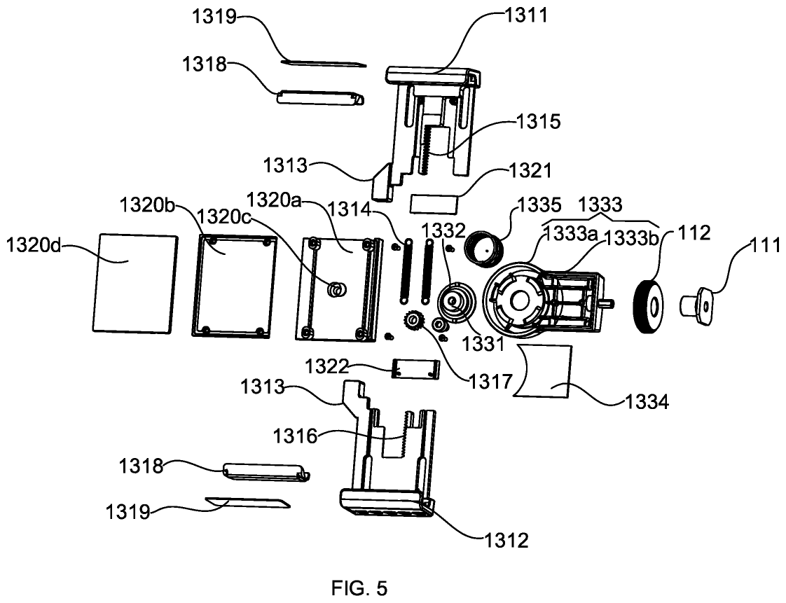

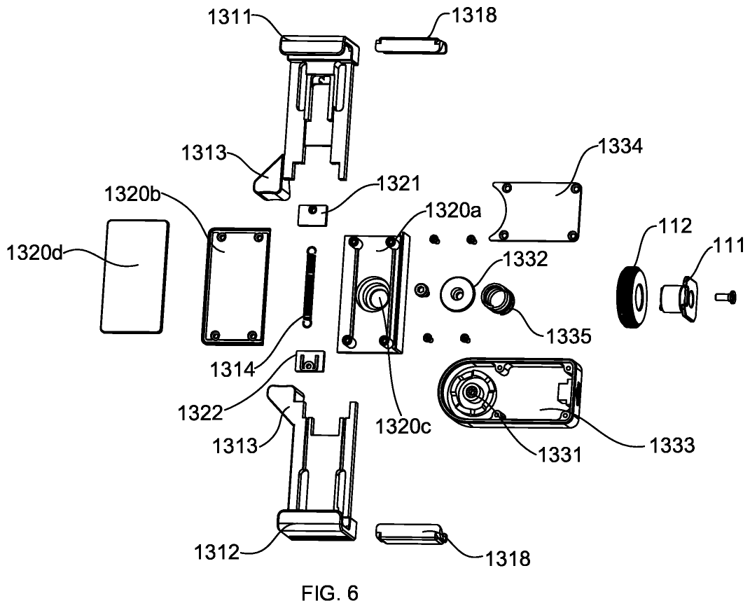

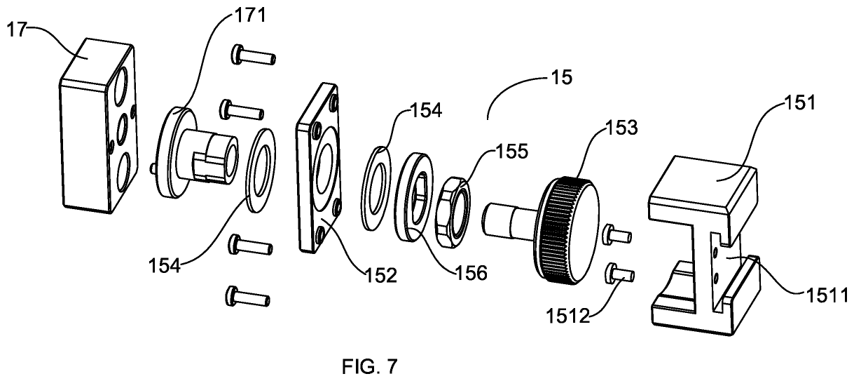

In some examples, as shown in FIG. 5 to FIG. 6, the cover body 1320 may include a first cover 1320a and a second cover 1320b. The first cover 1320a and the second cover 1320b are closed together to form an accommodation cavity. For example, the first cover 1320a and the second cover 1320b are each a box body having an opening, and the opening of the first cover 1320a may be disposed opposite to the opening of the second cover 1320b, so that the first cover 1320a and the second cover 1320b jointly enclose the accommodation cavity. Certainly, the first cover 1320a and the second cover 1320b may be provided with passages through which another component can enter the accommodation cavity.

The second cover 1320b may be provided with a through hole 1320c allowing the free end of the rotating shaft 1331 to pass therethrough. The anti-fall-off cover 1332 is disposed in the accommodation cavity. That is, the second cover 1320b may be relatively located on a rear side of the first cover 1320a, that is, the second cover 1320b may be located between the first cover 1320a and the support mechanism 133. At least a part of the second cover 1320b overlaps at least a part of the first cover 1320a along a front-to-back direction, so that the accommodation cavity is formed between the first cover 1320a and the second cover 1320b. The anti-fall-off cover 1332 may be located in the accommodating space. The anti-fall-off cover 1332 may be clamped or screwed to the rotating shaft 1331. The rotating shaft 1331 may be integrally provided with the support mechanism 133.

In addition, a part of the first clamping part 1311 and a part of the second clamping part 1312 may be disposed through the accommodation cavity. For example, parts such as at least a part of the first clamping plate of the first clamping part 1311 and at least a part of the second clamping plate of the second clamping part 1312 may be disposed through the accommodation cavity, to make the structure of the clamping device 1 more compact. In this case, a rear side surface of the mobile terminal device may be in contact with the first cover 1320a. The outer surface of the first cover 1320a, i.e., the front surface of the first cover 1320a, may be provided with a non-slip pad 1320d, so as to reduce relative sliding between the first cover 1320a and the mobile terminal device, thereby clamping the mobile terminal device more reliably.

In some examples, the support mechanism 133 may include a bottom housing 1333 and a cover plate 1334. The bottom housing 1333 includes a first part 1333a and a second part 1333b. The first part 1333a is provided with the rotating shaft 1331. The cover plate 1334 covers the second part 1333b.

For example, the bottom housing 1333 may be a box body with a front opening. The box body includes the first part 1333a. The first part 1333a is provided with the rotating shaft 1331 for rotatably connecting to the cover body 1320. The rotating shaft 1331 may be rotatably connected to the cover body 1320 at the front opening of the box body. The box body may further include a second part 1333b. The second part 1333b may extend towards the quick release interface of the image photographing apparatus from the first part 1333a, to prevent a component such as the cold shoe fixing piece 111 or the quick release interface from interfering with switching of the mobile terminal device between a horizontal position and a vertical position. The front opening corresponding to the second part 1333b may be covered by the cover plate 1334.

In some examples, as shown in FIG. 5, the rotating shaft 1331 may be integrally provided with the anti-fall-off cover 1332 thereof. The anti-fall-off cover 1332 is accommodated between the first cover 1320a and the second cover 1320b. One end of the anti-fall-off cover 1332 provided with the rotating shaft 1331 is disposed facing the second cover 1320b, and the rotating shaft 1331 is disposed through the through hole 1320c of the second cover 1320b. A part of the rotating shaft 1331 protruding out of the through hole 1320c is connected to the bottom housing 1333 of the support mechanism 133. The rotating shaft 1331 may be connected to the bottom housing 1333 in at least one of the following connection manners: interference fit, screw connection, bonding, and the like.

In some other examples, as shown in FIG. 6, the rotating shaft 1331 may be integrally provided with the bottom housing 1333. The rotating shaft 1331 is disposed on one side of the bottom housing 1333 facing the second cover 1320b, and the rotating shaft 1331 is disposed through the through hole 1320c of second cover 1320b. At least a part of the anti-fall-off cover 1332 is accommodated between the first cover 1320a and the second cover 1320b, and the anti-fall-off cover 1332 is connected to the rotating shaft 1331. The anti-fall-off cover 1332 may be connected to the rotating shaft 1331 in at least one of the following connection manners: interference fit, screw connection, bonding, and the like.

In some examples, as shown in FIG. 7 to FIG. 11, the clamping device 1 may further include a quick release seat 15 and a handle connection base 17. The quick release seat 15 is rotatably connected to the handle connection base 17. The quick release seat 15 is used for quick release connection with the cold shoe fixing piece 111. The handle connection base 17 is used for fixing to a handle of the image photographing apparatus.

The handle connection base 17 may be fixed to the handle of the image photographing apparatus in a common detachable connection manner such as screwing or clamping, so as to facilitate subsequent disassembly and assembly of the clamping device 1. Certainly, the handle connection base 17 may alternatively be integrally provided with the handle of the image photographing apparatus, or the handle connection base 17 may alternatively be welded to the image photographing apparatus, so as to reliably fix the two.

The quick release seat 15 may be rotatably connected to the handle connection base 17 via the rotating shaft 1331, so that a user can adjust a pitch angle of the mobile terminal device through the rotation of the quick release seat 15 relative to the handle connection base 17, for example, adjust an angle of the display screen of the mobile terminal device relative to the image photographing apparatus, so as to adjust the display screen of the mobile terminal device to a position convenient for the user to view.

For example, the quick release seat 15 may include a cold shoe seat 151 and a base 152. The base 152 is rotatably connected to the handle connection base 17. The cold shoe seat 151 and the base 152 are disposed opposite to each other and fixed together. A surface of the cold shoe seat 151 facing away from the base 152 is provided with a dovetail slot 1511 for engaging with the cold shoe fixing piece 111. In this way, an accommodating space enclosed by the base 152 and the cold shoe seat 151 may be used for accommodating other components, so as to make the structure of the clamping device 1 more compact.

The cold shoe seat 151 may include a main seat body. A surface of the main seat body facing away from the base 152 is provided with the dovetail slot 1511 for engaging with the cold shoe fixing piece 111. Two opposite sides of another surface of the main seat body are each provided with a connecting plate extending towards the base 152, and the connecting plates abut against the base 152, so that the cold shoe seat 151 and the base 152 can jointly enclose the accommodating space. Other two sides of the main seat body neighboring to the connecting plate may form an operation window communicating with the accommodating space, so as to facilitate a corresponding operation of a component disposed in the accommodating space.

In some examples, a limiting structure for limiting a clamping position of the cold shoe fixing piece 111 is disposed in the dovetail slot 1511 of the cold shoe seat 151, so as to limit the cold shoe fixing piece 111 at a specified clamping position thereof, thereby making the connection between the clamping mechanism 131 and the image photographing apparatus more reliable. For example, the limiting structure may include at least one limiting screw 1512 disposed on the cold shoe seat 151, and a part of the limiting screw 1512 is inserted in the dovetail slot 1511, to limit the movement of the cold shoe fixing piece 111.

The clamping device 1 further includes a thumb nut 153. A head portion of the thumb nut 153 is accommodated in the accommodating space enclosed by the base 152 and the cold shoe seat 151. A rod portion of the thumb nut 153 passes through the through hole 1320c opened in the base 152 and is fixed to the handle connection base 17.

The rod portion of the thumb nut 153 is rotatably disposed in the through hole 1320c of the base 152. The handle connection base 17 may be provided with a fixing hole matching the rod portion of the thumb nut 153, so that the thumb nut 153 can be fixedly connected to the handle connection base 17. For example, the rod portion of the thumb nut 153 may be in interference fit with the fixing hole.

In this way, a user may rotate the head portion of the thumb nut 153 to enable the thumb nut 153 to drive the handle connection base 17 and the image photographing apparatus to rotate, thereby adjusting the pitch angle of the mobile terminal device. Certainly, the user may alternatively rotate the quick release seat 15 to enable the quick release seat 15 to drive the mobile terminal device to rotate, thereby adjusting the pitch angle of the mobile terminal device.

In some exemplary embodiments, the quick release seat 15 is configured to include the cold shoe seat 151 and the base 152 that are separate of each other, and the thumb nut 153 is further provided, so that the clamping device 1 can be connected to the image photographing apparatus, and the clamping device 1 can rotate relative to the image photographing apparatus, that is, the display screen of the mobile terminal device can rotate relative to the image photographing apparatus. Thereby, the convenience of user operation and observation is further improved.

The clamping device 1 may further include a hollow fixing seat 171. The fixing seat 171 is disposed between the base 152 and the handle connection base 17. The rod portion of the thumb nut 153 passes through a hollow cavity of the fixing seat 171 and is fixed to the handle connection base 17. The fixing seat 171 may be a hollow cylinder disposed between the base 152 and the handle connection base 17. The fixing seat 171 may be fixedly connected to the handle connection base 17. A size of the fixing seat 171 may be smaller than that of the base 152, that is, a radial dimension of the fixing seat 171 may be less than a dimension of the base 152 in a corresponding direction, so that there is a particular gap between the fixing seat 171 and the base 152 to avoid mutual interference.

In some examples, the rod portion of the thumb nut 153 is provided with at least one gasket. For example, two sides of the through hole 1320c opened in the base 152 are each provided with one gasket, to reduce wear on the base 152 during rotation of the quick release seat 15 relative to the handle connection base 17. The gaskets are in some examples Teflon gaskets 154.

In some examples, a pre-tightening nut 155 is further disposed between the head portion of the thumb nut 153 and the base 152, so as to provide an appropriate pre-tightening force between the head portion of the thumb nut 153 and the base 152. In addition, a pre-tightening washer 156 is further disposed between the pre-tightening nut 155 and the base 152, to reduce the wear on the base 152 during rotation of the head portion of the thumb nut 153 relative to the base 152.

Some exemplary embodiments further provide a clamping mechanism 131. The structure, function and implementation of the clamping mechanism 131 in some exemplary embodiments may be the same as those of the clamping mechanism 131 in the foregoing embodiment. Details will not be described herein again.

Some exemplary embodiments further provide a photographing apparatus, including a camera and the clamping device 1 in any one of the foregoing embodiments. The cold shoe fixing piece 111 of the clamping device 1 is clamped on a hot shoe of the camera. The camera is the image photographing apparatus in the foregoing embodiments. The structure, function and implementation of the clamping device 1 may be the same as those of the clamping device 1 in the foregoing embodiments. Details will not be described herein again.

Some exemplary embodiments further provide a photographing apparatus, including a handle and the clamping device 1 in any one of the foregoing embodiments. The handle connection base 17 of the clamping device 1 is fixed to a side surface of the handle. The structure, function and an implementation of the clamping device 1 in some exemplary embodiments may be the same as those of the clamping device 1 in the foregoing embodiments. Details will not be described herein again.

The handle is a handheld device that is configured to carry an image photographing apparatus and that can be held by a user. The clamping device 1 may be connected to the image photographing apparatus via the handle. For example, the handle may be provided with a gimbal mechanism, so as to adjust a photographing angle of the image photographing apparatus by controlling the movement of the gimbal mechanism. In addition, the handle may be further provided with an operation member such as a pressing key or a sensing key, so that a user can control, by using the handle, the image photographing apparatus to perform some functions. The specific structure of the handle is not limited herein in some exemplary embodiments. Common settings in the field may be used for the handle.

In the present disclosure, unless otherwise specified and defined, the terms such as “mounted”, “connected to”, “connected”, and “fixed” should be understood in a broad sense. For example, a connection may be a fixed connection, a detachable connection, or an integral connection; a direct connection, or an indirect connection by means of an intermediate medium, or internal communication between two elements, or an interactive relationship between two elements. A person of ordinary skill in the art may understand specific meanings of the foregoing terms in the present disclosure based on a specific situation.

In addition, reference to the term “one embodiment”, “some embodiments”, “an example”, “a specific example” or “some examples” or the like in the descriptions means that a specific feature, structure, material, or characteristic described in combination with the embodiment(s) or example(s) is included in at least one embodiment or example of the present disclosure. In this specification, the schematic description of the above terms is not necessarily for the same embodiment or example. Moreover, the described specific feature, structure, material, or characteristic may be combined in any suitable manner in any one or more embodiments or examples. In addition, without contradiction, a person skilled in the art may combine different embodiments or examples described in this specification and features of the different embodiments or examples, without any contradiction.

Finally, although the advantages associated with some embodiments of the technology have been described in the context of these embodiments, other embodiments may also include such advantages. In addition, not all advantages of the present disclosure are described in detail in all of the embodiments. Advantages objectively brought about by the technical features in the embodiments shall be considered as advantages of the present disclosure over the existing technology and all fall within the scope of protection of the present disclosure.

What is claimed is:

1. A clamping mechanism for clamping a mobile terminal device, comprising:
a first clamping part and a second clamping part disposed opposite to the first clamping part, to enclose an accommodating space configured to accommodate a mobile terminal device; and
a manual operation part, disposed outside the accommodating space and configured to drive the first clamping part and the second clamping part to move between a clamping position and a releasing position, wherein
at the clamping position, the first clamping part and the second clamping part are capable of clamping the mobile terminal device, and
at the releasing position, the first clamping part and the second clamping part are capable of releasing the mobile terminal device.

2. The clamping mechanism according to claim 1, wherein the manual operation part comprises at least one pressing protrusion configured to drive the first clamping part and the second clamping part to move from the clamping position to the releasing position; and
the at least one pressing protrusion is disposed on at least one of the first clamping part or the second clamping part.

3. The clamping mechanism according to claim 2, wherein the at least one pressing protrusion comprises
a pressing protrusion on the first clamping part; and
a pressing protrusion on the second clamping part opposite to the pressing protrusion on the first clamping part.

4. The clamping mechanism according to claim 3, wherein the pressing protrusion on the first clamping part is located on a side of the first clamping part facing the second clamping part; and
the pressing protrusion on the second clamping part is located on a side of the second clamping part facing the first clamping part.

5. The clamping mechanism according to claim 1, further comprising:
an elastic reset member to reset the first clamping part and the second clamping part from the releasing position to the clamping position.

6. The clamping mechanism according to claim 5, wherein the elastic reset member is a tension spring; and
two ends of the tension spring are respectively fixed to the first clamping part and the second clamping part, or one of the two ends of the tension spring is mounted to a fixing position.

7. The clamping mechanism according to claim 1, wherein the first clamping part comprises a first engaging rack facing the second clamping part;
the second clamping part comprises a second engaging rack facing the first clamping part; and
the first engaging rack is engaged with the second engaging rack to move the first clamping part and the second clamping part in opposite directions, under operation of the manual operation part, to clamp or release the mobile terminal device.

8. The clamping mechanism according to claim 7, further comprising: a transmissive gear,
wherein the first engaging rack are in transmissive connection with the second engaging rack via the transmissive gear.

9. The clamping mechanism according to claim 1, wherein at least one of an inner surface of the first clamping part for contacting the mobile terminal device, or an inner surface of the second clamping part for contacting the mobile terminal device comprises an elastic pad.

10. The clamping mechanism according to claim 9, wherein the elastic pad comprises at least one part to contact a side of the mobile terminal device, and a surface of the at least one part is a cambered surface.

11. The clamping mechanism according to claim 1, wherein a decorative piece is disposed on at least one of an outer surface of the first clamping part facing away from the mobile terminal device, or an outer surface of the second clamping part facing away from the mobile terminal device.

12. The clamping mechanism according to claim 1, further comprising:
a cover body,
wherein the first clamping part and the second clamping part are slidably disposed on a first surface of the cover body.

13. A clamping device for mounting a mobile terminal device to a hot shoe of an image photographing apparatus, comprising:
a quick release structure, comprising
a cold shoe fixing piece to connect to a quick release interface of the hot shoe, and
a first locking structure to selectively quickly lock the cold shoe fixing piece to the hot shoe, or quickly unlock the cold shoe fixing piece from the hot shoe; and
a clamping assembly fixed to the cold shoe fixing piece to selectively clamp or release a mobile terminal device.

14. The clamping device according to claim 13, wherein the first locking structure comprises:
a stud configured to fix to the clamping assembly on the cold shoe fixing piece; and
a locking nut mounted on the stud.

15. The clamping device according to claim 13, further comprising a quick release seat and a handle connection base, wherein
the quick release seat is rotatably connected to the handle connection base,
the quick release seat is in quick release connection with the cold shoe fixing piece, and
the handle connection base is fixed to a handle of an image photographing apparatus.

16. The clamping device according to claim 13, wherein the clamping assembly comprises a clamping mechanism connected to the cold shoe fixing piece;
a clamping mechanism comprising:
a first clamping part,
a second clamping part disposed opposite to the first clamping part to enclose an accommodating space configured to accommodate a mobile terminal device, and
a manual operation part, disposed outside the accommodating space configured to drive the first clamping part and the second clamping part to move between a clamping position and a releasing position, wherein
at the clamping position, the first clamping part and the second clamping part are capable of clamping the mobile terminal device, and
at the releasing position, the first clamping part and the second clamping part are capable of releasing the mobile terminal device.

17. The clamping device according to claim 16, wherein the clamping mechanism is rotatable relative to the cold shoe fixing piece.

18. The clamping device according to claim 17, wherein the clamping mechanism is configured to selectively rotates the mobile terminal device to a horizontal position or a vertical position.

19. The clamping device according to claim 16, wherein the clamping assembly further comprises a support mechanism fixed to the cold shoe fixing piece; and
the clamping mechanism is configured to rotatably connected to the support mechanism.

20. A photographing apparatus, comprising:
a camera; and
a clamping device, wherein a cold shoe fixing piece of the clamping device is clamped on a hot shoe of the camera, the clamping device comprises:
a quick release structure, comprising the cold shoe fixing piece to connect to a quick release interface of the hot shoe, and a first locking structure to selectively quickly lock the cold shoe fixing piece to the hot shoe or quickly unlock the cold shoe fixing piece from the hot shoe, and
a clamping assembly fixed to the cold shoe fixing piece to selectively clamp or release a mobile terminal device.
